(19) United States
(12) Patent Application Publication
(10) Pub. No.: US 2012/0063339 A1
(43) Pub. Date: Mar. 15, 2012

(54) METHOD AND APPARATUS FOR TRANSMITTING PACKET IN WIRELESS NETWORK

(75) Inventor: Jun Keun SONG, Daejeon (KR)

(73) Assignee: Electronics and Telecommunications Research Institute, Daejeon (KR)

(21) Appl. No.: 13/228,569

(22) Filed: Sep. 9, 2011

(30) Foreign Application Priority Data
Sep. 9, 2010 (KR) 10-2010-0088518

(51) Int. Cl. H04W 24/00; H04W 84/02; H04W 40/00

(52) U.S. Cl. 370/252; 370/328; 370/338

(57) ABSTRACT

An apparatus for transmitting a packet in a wireless network includes: a delay time calculator for calculating an expected delay time to a destination based on the number of hops for a received packet to be transmitted to the destination and a channel access time; and a packet processor for discarding the received packet or inserting the received packet into a transmission queue according to a result of a comparison made between the expected delay time and a preset allowable value. The delay time calculator calculates the number of hops by a routing protocol used in the apparatus or by an analysis of a header portion of the received packet.

### CROSS-REFERENCE(S) TO RELATED APPLICATION(S)

The present invention claims priority of Korean Patent Application No. 10-2010-0088518 filed on Sep. 9, 2010, which is incorporated herein by reference.

### FIELD OF THE INVENTION

The present invention relates to a packet transmission in a wireless network, and more particularly, to a method and apparatus for transmitting a packet in a wireless network which can reduce channel waste and increase transmission rate.

### BACKGROUND OF THE INVENTION

As a wireless communication system is increasingly used due to providing portability and convenience of use, a wireless communication system in a multi-hop mesh environment, rather than in a simple master-slave structure, is increasingly used. Multi-hop transmission is necessary for data transfer in a conventional environment with no infrastructure, and there is an increasing number of applications requiring real-time transmission of data, such as voice and video calls. Although IEEE 802.11e provides multi queue-based QoS (Quality of Service) in order to guarantee such data transmission, QoS cannot be guaranteed in a multi-hop environment because data is transmitted depending on priority determined by data type such as voice, video or the like. Particularly, if the transmission of real-time data is not completed within a predetermined time, channels are wasted for no reason. Thus, in order to increase the use of wireless channels in case real-time data does not arrive within a preset time, it is better not to transmit it to reduce channel waste.

Consequently, there is a need for a technique which makes it efficient to transmit real-time data in a multi-hop wireless communication environment and minimizes unnecessary channel use.

### SUMMARY OF THE INVENTION

The present invention provides an apparatus and method for transmitting a packet in a wireless network, which can reduce channel use caused by meaningless real-time data packets not transmitted within a given time by calculating an expected delay time taken for a received packet to reach a destination node and transmitting the received packet based on the calculated expected delay time or discarding it.

The present invention further provides an apparatus and method for transmitting a packet in a wireless network capable of guaranteeing the transmission rate of real-time data packets, which are less meaningful than packets stored in a transmission queue, by adjusting the priority of a received packet by making a comparison of an expected delay time, a preset allowable value, and a total expected transmission time of the packets stored in the transmission queue or discarding the received packet.

In accordance with an aspect of the present invention, there is provided with an apparatus for transmitting a packet in a wireless network including: a delay time calculator for calculating an expected delay time to a destination based on the number of hops for a received packet to be transmitted to the destination and a channel access time; and a packet processor for discarding the received packet or inserting the received packet into a transmission queue according to a result of a comparison made between the expected delay time and a preset allowable value.

In accordance with another aspect of the present invention, there is provided with an apparatus for transmitting a packet in a wireless network including: a delay time calculator for calculating an expected delay time to a destination based on the number of hops for a received packet to be transmitted to the destination and a channel access time; an expected time calculator for calculating a first expected transmission time of packets stored in a transmission queue when the expected delay time is shorter than a preset allowable value; and a packet processor for storing the received packet in the transmission queue when the expected delay time is shorter than the first expected transmission time.

In accordance with still another aspect of the present invention, there is provided with a method for transmitting a packet in a wireless network including: receiving a packet via the wireless network; calculating an expected delay time to a destination based on the number of hops for the received packet to be transmitted to the destination and a channel access time; making a comparison between the expected delay time and a preset allowable value; and inserting the received packet into a transmission queue when the expected delay time is shorter than the preset allowable value.

In accordance with still another aspect of the present invention, there is provided with a method for transmitting a packet in a wireless network including: upon receipt of a packet, calculating an expected delay time to a destination based on the number of hops for the received packet to be transmitted to the destination and a channel access time; calculating a first expected transmission time of packets stored in a transmission queue when the expected delay time is shorter than a preset allowable value; and inserting the received packet into the transmission queue when the expected delay time is shorter than the first expected transmission time.

### BRIEF DESCRIPTION OF THE DRAWINGS

The objects and features of the present invention will become apparent from the following description of embodiments, given in conjunction with the accompanying drawings, in which:

FIG. 1 is a block diagram showing an apparatus for transmitting a packet in a wireless network in accordance with one embodiment of the present invention;

FIG. 2 is an illustration for explaining channel access in accordance with embodiments of the present invention;

FIG. 3 is a block diagram showing an apparatus for transmitting a packet in accordance with another embodiment of the present invention; and

FIG. 4 is a flowchart showing a process of processing a packet in a wireless network environment in accordance with said another embodiment of the present invention.

### DETAILED DESCRIPTION OF THE EMBODIMENTS

Embodiments of the present invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of respective blocks of block diagrams attached herein and respective steps of a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram. Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective steps of the sequence diagram.

Moreover, the respective blocks or the respective steps may indicate modules, segments, or some of codes including at least one executable instruction for executing a specific logical function(s). In several alternative embodiments, it is noticed that functions described in the blocks or the steps may run out of order. For example, two successive blocks and steps may be substantially executed simultaneously or often in reverse order according to corresponding functions.

Hereinafter, embodiments of the present invention will be described in detail with reference to the accompanying drawings which form a part hereof.

FIG. 1 is a block diagram showing an apparatus for transmitting a packet in a wireless network in accordance with an embodiment of the present invention. The apparatus includes a delay time calculator 100, a packet processor 110, a transmission queue 120 and the like.

Upon receipt of a packet from a wireless network, the delay time calculator 100 calculates an expected delay time to a destination node based on the number of hops for the packet to be transmitted to its destination node, i.e., a wireless terminal of the destination and the channel access time of the packet.

Although a method of predicting a channel access time may be slightly different based on the protocol used in the packet transmitting apparatus, a MAC protocol using a CSMA/CA algorithm generally involves a backoff for ensuring fair access between wireless terminals and an IFS (inter-frame spacing) indicating the minimum space between frames, for channel access. That is, although there are detailed differences among protocols, a channel access method includes processes of an IFS, a backoff, and a transmission.

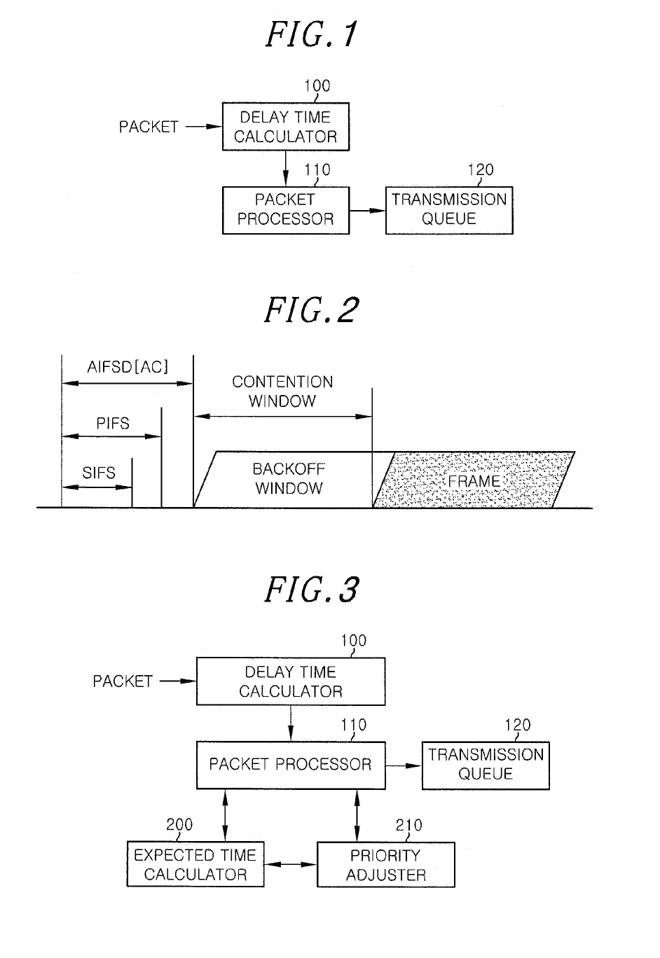

In an example of channel access based on IEEE 802.11E, data is transmitted with priority on audio and video data to guarantee QoS. As shown in FIG. 2, priority is determined by classifying data by data type (access category (AC)), and the data is transmitted based on the determined priority.

As can be seen from the foregoing description, the delay time calculator 100 calculates an expected delay time by predicting the number of hops for a packet to reach its destination node based on a minimum amount of time required for transmitting a frame once. In other words, the expected delay time taken for a packet to be transmitted to its destination node can be calculated by the following Eq. 1:

Expected Delay Time=Number of Hops*Channel Access Time Eq. 1

In Eq. 1, the number of hops may be obtained by a routing protocol of the transmitting apparatus or through a reserved header portion of the packet, and the channel access time can be calculated based on the characteristics of the protocol used in the transmitting apparatus. For example, in the IEEE 802.11, time for RTS/CTS (request to send and clear to send) transmission may be added, and, if an acknowledgment frame is used for transmission acknowledgment, a time for transmitting an acknowledgment frame can be added.

The packet processor 110 discards a packet or inserts a packet into the transmission queue 120 by making a comparison between the expected delay time and a preset allowable value. More specifically, when the expected delay time is longer than or equal to the preset allowable value, the packet processor 110 discards the packet, and otherwise, inserts the packet into the transmission queue 120. The packet inserted into the transmission queue 120 is be transmitted to an external node via a wireless network.

In an embodiment of the present invention, a packet may be an audio, video, or sensor data packet, which requires real-time transmission, and the delay time calculator 100 calculates the expected delay time only for a packet requiring real-time transmission.

According to the packet transmitting apparatus in accordance with an embodiment of the present invention, channel use caused by real-time data, which becomes meaningful only when it is transmitted within a given time, can be reduced by calculating and predicting an expected delay time for a packet requiring real-time transmission in a wireless network environment.

In the following description, an apparatus for transmitting a packet in a wireless network in accordance with another embodiment of the present invention will be described with reference to FIG. 3. However, this embodiment of the present invention is different from the previous embodiment of the present invention in that a packet is processed by having priority changed depending on the expected transmission time for a packet in the transmission queue. Therefore, the following description will be focused on the differences and the same explanations and reference numerals as the previous embodiment will be applied to describe the same parts.

FIG. 3 is a block diagram showing an apparatus for transmitting a packet in accordance with another embodiment of the present invention. This apparatus includes a delay time calculator 100, an expected time calculator 200, a priority adjuster 210, a packet processor 110, a transmission queue 120 and the like. An expected delay time calculated by the delay time calculator 100 is provided to the expected time calculator 200.

When the expected delay time of a received packet is shorter than a preset allowable value, the expected time calculator 200 calculates a total expected transmission time for the packets stored in the transmission queue 120.

That is, the expected time calculator 200 calculates the expected transmission time for each packet that should be transmitted before the received packet, based on the number of hops and a channel access time in the same manner as the delay time calculator 100. Then, the expected time calculator 200 adds all the calculated expected transmission times to calculate the total expected transmission time and provides it to the packet processor 110.

The priority adjuster 210 adjusts, i.e., raises, the priority of a received packet when it is determined that the total expected transmission time is equal to or longer than the expected delay time of the received packet.

As the priority of the received packet has been adjusted, the expected time calculator 200 calculates expected transmission times for packets that should be transmitted before the received packet, and adds the calculated expected transmission times to recalculate the total expected transmission time and provides it to the packet processor 110.

The packet processor 110 processes the received packet by comparing the expected delay time for the received packet with the total expected transmission time, provided from the expected time calculator 200, for the packets in the transmission queue 120. That is, if the expected delay time of the received packet is shorter than the total expected transmission time, the received packet is inserted into the transmission queue 120, and otherwise, a request for adjusting the priority of the received packet is sent to the priority adjuster 210.

After the priority of the received packet is adjusted by the priority adjuster 210, the packet processor 110 receives, from the expected time calculator 200, the total expected transmission time for the packets that should be transmitted before the packet whose priority is adjusted, i.e., the packets with a higher priority than the received packet, and processes the received packet by making a comparison between the total expected transmission time and the expected delay time of the received packet. That is, if the expected delay time of the received packet is longer than or equal to the total expected transmission time, the packet is discarded, and otherwise, the received packet is inserted into the transmission queue 120.

The transmission queue 120 has a multi-queue configuration. One example of the multi-queue configuration includes a real-time queue, an ordinary queue, and a non-real-time queue depending on the types of packets. The real-time queue stores a packet that requires real-time transmission, the ordinary queue stores a packet that requires ordinary time transmission, and the non-real-time queue stores a packet that does not actually require real-time transmission.

For the multi-queue configuration of the transmission queue 120 in this manner, the packet processor 110 inserts the received packet into the corresponding queue based on the type of the received packet.

According to the apparatus for transmitting a packet in accordance with another embodiment of the present invention, the transmission rate of real-time data can be guaranteed by adjusting the priority of the received packet if the expected delay time of the received packet is longer than or equal to the total expected transmission time of the packets stored in the transmission queue 120.

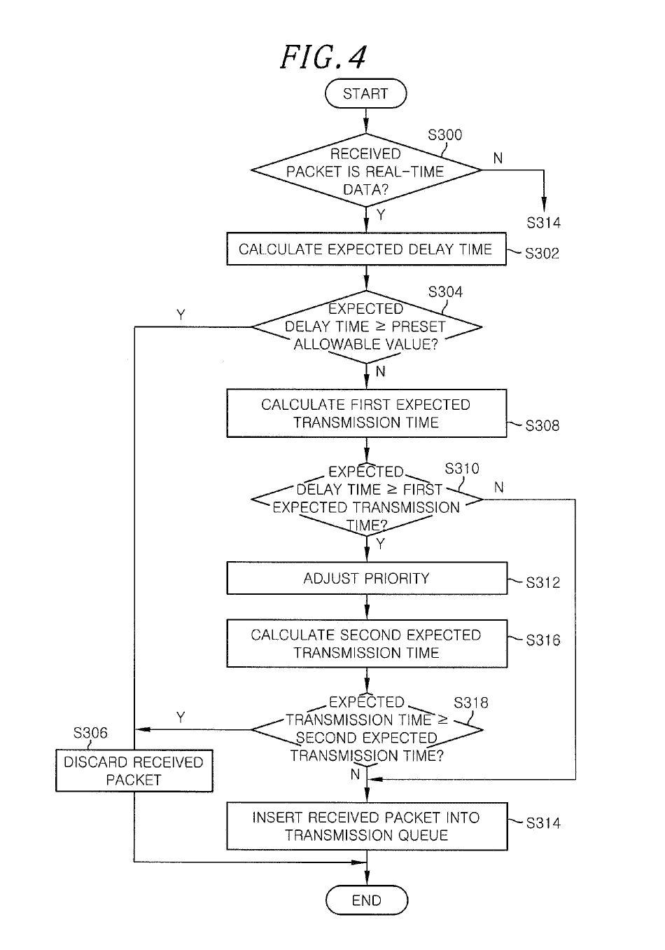

A process for the packet transmitting apparatus having the above configuration to process a received packet will now be described with reference to FIG. 4.

FIG. 4 is a flow chart showing a process of processing a received packet in a wireless network environment in accordance with another embodiment of the present invention.

As shown in FIG. 4, upon receipt of a packet, the delay time calculator 100 in the transmitting apparatus determines whether the received packet is real-time data or not in step S300.

As a result of the determination in step S300, if the received packet is real-time data, the delay time calculator 100 calculates an expected delay time taken for the received packet to reach a destination node based on the number of hops to the destination node and the channel access time in step S302. The calculated expected delay time is then provided to the packet processor 110.

The packet processor 110 determines whether the calculated expected delay time is longer than or equal to a preset allowable value, i.e., a maximum real-time allowable value in step S304.

As a result of the determination in step S304, if the calculated expected delay time is longer than or equal to the preset allowable value, the packet processor 110 discards the received packet in step S306.

On the other hand, as a result of the determination in step S304, if the calculated expected delay time is shorter than the preset allowable value, the packet processor 110 requests the expected time calculator 200 to send a total expected transmission time. Accordingly, the expected time calculator 200 calculates the expected transmission times of packets stored in the transmission queue 120, and then adds all of them to calculate the total expected transmission time (first expected transmission time) in step S308 and provides it to the packet processor 110.

The packet processor 110 determines whether the calculated expected delay time is longer than or equal to the first expected transmission time in step S310.

As a result of the determination in step S310, if the calculated expected delay time is longer than or equal to the first expected transmission time, the packet processor 110 requests the priority adjuster 210 to adjust the priority of the received packet. Accordingly, the priority adjuster 210 adjusts the priority of the received packet by raising the priority of the received packet by comparative analysis between the packets stored in the transmission queue 120 and the received packet in step S312.

On the other hand, as a result of the determination in step S310, if the calculated expected delay time is shorter than the first expected transmission time, the packet processor 110 inserts the received packet into the transmission queue 120 in step S314.

In step S316, the expected time calculator 200 calculates an expected transmission time of each packet having a higher priority than the received packet whose priority has been adjusted and then adds all of them to calculate a second expected transmission time and provide it to the packet processor 110.

The packet processor 110 determines whether the expected delay time is longer than or equal to the second expected transmission time in step S318.

As a result of the determination in step S318, if the expected delay time is longer than or equal to the second expected transmission time, the packet processor 110 proceeds to step S306 to discard the received packet. Otherwise, the packet processor 110 proceeds to step S314 to insert the received packet into the transmission queue 120.

As the result of determination in step S300, if the received packet is not data requiring real-time transmission, the packet processor 110 inserts the received packet into the transmission queue 120.

According to the method for transmitting a packet in accordance with the embodiments of the present invention, channel use caused by meaningless real-time data packets not transmitted within a given time can be reduced by calculating an expected delay time taken for a received packet to reach a destination node and transmitting or discarding the received packet based on the calculated expected delay time.

Moreover, the transmission rate of real-time data packets, which can be less meaningful than packets stored in the transmission queue 120, is guaranteed by adjusting the priority of a received packet or discarding the received packet by making a comparison of an expected delay time of the received packet and a preset allowable value, and a comparison of the expected delay time and a total expected transmission time of packets stored in the transmission queue 120.

While the invention has been shown and described with respect to the preferred embodiments, it will be understood by those skilled in the art that various changes and modifications may be made without departing from the spirit of the invention as defined in the following claims.

What is claimed is:

1. An apparatus for transmitting a packet in a wireless network comprising:
a delay time calculator for calculating an expected delay time to a destination based on the number of hops for a received packet to be transmitted to the destination and a channel access time; and
a packet processor for discarding the received packet or inserting the received packet into a transmission queue according to a result of a comparison made between the expected delay time and a preset allowable value.

2. The apparatus of claim 1, wherein the delay time calculator calculates the number of hops by a routing protocol used in the apparatus or by an analysis of a header portion of the received packet.

3. The apparatus of claim 1, wherein the delay time calculator calculates the channel access time for the received packet by taking the time for RTS/CTS transmission into account when the protocol used in the transmitting apparatus is IEEE 802.11 or by taking the transmission time of an acknowledgment frame into account when the transmitting apparatus uses the acknowledgment frame for acknowledging the transmission of the packet.

4. The apparatus of claim 1, wherein the received packet is an audio, video, or sensor data packet, which requires real-time transmission.

5. An apparatus for transmitting a packet in a wireless network comprising:
a delay time calculator for calculating an expected delay time to a destination based on the number of hops for a received packet to be transmitted to the destination and a channel access time;
an expected time calculator for calculating a first expected transmission time of packets stored in a transmission queue when the expected delay time is shorter than a preset allowable value; and
a packet processor for storing the received packet in the transmission queue when the expected delay time is shorter than the first expected transmission time.

6. The apparatus of claim 5, further comprising a priority adjuster for adjusting the priority of the received packet when the expected delay time is longer than or equal to the first expected transmission time,
wherein the expected time calculator calculates a second expected transmission time of packets having a higher priority than the received packet whose priority is adjusted and provides the second expected transmission time to the packet processor, and
the packet processor discards the received packet or inserts the received packet into the transmission queue by a result of a comparison made between the expected delay time and the second expected transmission time.

7. The apparatus of claim 6, wherein the priority adjuster raises the priority of the received packet.

8. The apparatus of claim 5, wherein the expected time calculator calculates the first expected transmission time for the packets stored in the transmission queue which should be transmitted before the received packet based on the channel access time.

9. The apparatus of claim 5, wherein the delay time calculator calculates the number of hops by a routing protocol used in the apparatus or by an analysis of a header portion of the received packet.

10. The apparatus of claim 5, wherein the delay time calculator calculates the channel access time for the received packet by taking the time for RTS/CTS transmission into account when the protocol of the apparatus is IEEE 802. 11 or by taking the transmission time of an acknowledgment frame into account when the transmitting apparatus uses the acknowledgment frame for acknowledging the transmission of the packet.

11. The apparatus of claim 5, wherein the expected delay time is calculated for an audio, video, or sensor data packet, which requires real-time transmission.

12. A method for transmitting a packet in a wireless network comprising:
receiving a packet via the wireless network;
calculating an expected delay time to a destination based on the number of hops for the received packet to be transmitted to the destination and a channel access time;
making a comparison between the expected delay time and a preset allowable value; and
inserting the received packet into a transmission queue when the expected delay time is shorter than the preset allowable value.

13. The method of claim 12, wherein said calculating an expected delay time further includes determining whether the received packet is an audio, video, or sensor data packet, which requires real-time transmission, and calculates, if it is determined that the received packet is a packet which requires real-time transmission, the expected delay time for the received packet.

14. A method for transmitting a packet in a wireless network comprising:
upon receipt of a packet, calculating an expected delay time to a destination based on the number of hops for the received packet to be transmitted to the destination and a channel access time;
calculating a first expected transmission time of packets stored in a transmission queue when the expected delay time is shorter than a preset allowable value; and
inserting the received packet into the transmission queue when the expected delay time is shorter than the first expected transmission time.

15. The method of claim 14, further comprising adjusting the priority of the received packet when the expected delay time is greater than or equal to the first expected transmission time, and
said inserting the received packet into the transmission queue includes:
calculating a second expected transmission time of packets having a higher priority than the received packet whose priority is adjusted; and
inserting the received packet into the transmission queue when the expected delay time is shorter than the second expected transmission time.

16. The method of claim 15, wherein said adjusting the priority of the received packet raises the priority of the received packet.

17. The method of claim 14, wherein said calculating a first expected transmission time calculates the first expected transmission time for the packets stored in the transmission queue which should be transmitted before the received packet based on the channel access time.
